(19) United States
(12) Patent Application Publication
(10) Pub. No.: US 2020/0117780 A1
(43) Pub. Date: Apr. 16, 2020

(54) MULTI-FACTOR BIOMETRIC AUTHENTICATION

(71) Applicant: CA, Inc., New York, NY (US)

(72) Inventors: MOHAMMED MUJEEB KALADGI, BANGALORE (IN); KIRAN KUMAR B.S, BANGALORE (IN); RUQIYA NIKHAT KALADGI, BANGALORE (IN); STEVEN CORNELIS VERSTEEG, VICTORIA (AU)

(21) Appl. No.: 16/159,919

(22) Filed: Oct. 15, 2018

(51) Int. Cl. G06F 21/32; G06F 21/40; G06K 9/00; G06F 3/01

(52) U.S. Cl. CPC G06F 21/32; G06F 21/40; G06K 2009/0006; G06F 3/011; G06K 9/00013

(57) ABSTRACT

A biometric sensor can be integrated into a user device to enable multifactor biometric authentication of a user on the user device. The biometric sensor can comprise at fingerprint scanner and a heartrate detector, the heartrate detector further comprising an optical input device and a light emitting diode (LED). The fingerprint scanner comprises a camera encircling the edge of the biometric sensor and detects and scans the users fingerprint to compare to a stored fingerprint to authenticate the users fingerprint. The heartrate detector can determine a heartrate of the user. Based on the detected heartrate of the user and utilizing a validation profile it can be determined if the user is, for example, a live person, is under duress, or sleeping. If the heartrate data is validated by the user device within certain allowable parameters, and the fingerprint of the user is authenticated, access to the user device is enabled.

### BACKGROUND

With sensitive data becoming more commonly stored on user devices, more robust security features are being implemented to safeguard such user devices and prevent access to unauthorized users. Conventional security features, for example login credentials, single fingerprint scans, or security tokens, however, can be insufficient as an unauthorized user can still gain access to the user device. For instance, in the case of conventional biometric authentication (e.g. fingerprint scanning alone) several shortcomings can be taken advantage of to gain unauthorized access to the user device; a plastic fingerprint can be used, the finger of an authorized user can be used after death, and the finger of an authorized user can still be utilized if the authorized user is sleeping or under duress. According to the technology described herein, the deficiencies of conventional authentication systems and processes are overcome through the use of a multifactor biometric authentication scheme.

### SUMMARY

This summary is provided to introduce a selection of concepts in a simplified form that are further described below in the detailed description. This summary is not intended to identify key features or essential features of the claimed subject matter, nor is it intended to be used in isolation as an aid in determining the scope of the claimed subject matter.

Embodiments of the technology described herein are directed towards methods and systems for authenticating a user on a user device through multifactor biometric authentication. In some embodiments, a heartrate based “liveness” test can be integrated into the authentication process to achieve advanced user authentication. A biometric sensor, or button, can be integrated into a user device to gather fingerprint data and heartrate data, to be used in conjunction with other data acquired by the user device to determine biometric results for authenticating a user and enable access to the user device. According to some embodiments of the technology described herein, the biometric sensor combines a fingerprint scanner and a heartrate detector into a single biometric sensor to implement the multifactor biometric authentication process. Thus the single biometric sensor mechanism can be employed to authenticate a user based on multiple biometric factors in a single login or authentication event.

In some embodiments, the biometric sensor can detect a physical contact between a user's finger and the biometric sensor. The fingerprint scanner can scan a user's fingerprint and the heartrate detector can measure the heartrate of the user. The scanned fingerprint data and the measured heartrate data can be compared to stored fingerprint and heartrate data to authenticate the user and enable access to the user device. In some embodiments, the user device can utilize one or more validation profiles and other acquired data to determine if the heartrate data is valid. Accordingly, an improvement in authentication processes and mechanisms on user devices is provided by enabling the multifactor biometric authentication technology described herein.

### BRIEF DESCRIPTION OF THE DRAWINGS

Aspects of the technology presented herein are described in detail below with reference to the attached drawing figures, wherein:

FIG. 1 is a diagram of an example operating environment in accordance with some aspects of the technology described herein;

FIG. 2 is a block diagram depicting an example computing architecture, in accordance with some aspects of the technology described herein;

FIG. 3 is a diagram of an example validation profile for authenticating a user utilizing biometrics, in accordance with some aspects of the technology described herein;

FIG. 4 is an example system and communication schematic, in accordance with some aspects of the technology described herein;

FIG. 5 is a flow diagram showing a method for authenticating a user utilizing biometrics, in accordance with some aspects of the technology described herein;

FIG. 6 is a flow diagram showing a method for authenticating a user utilizing biometrics, in accordance with some aspects of the technology described herein;

FIG. 7 is a block diagram of an exemplary computing environment suitable for use in implementing embodiments of the present invention.

### DETAILED DESCRIPTION OF THE INVENTION

The subject matter of aspects of the present disclosure is described with specificity herein to meet statutory requirements. However, the description itself is not intended to limit the scope of this patent. Rather, the inventors have contemplated that the claimed subject matter might also be embodied in other ways, to include different steps or combinations of steps similar to the ones described in this document, in conjunction with other present or future technologies. Moreover, although the terms “step” and/or “block” can be used herein to connote different elements of methods employed, the terms should not be interpreted as implying any particular order among or between various steps herein disclosed unless and except when the order of individual steps is explicitly described. As used herein, the singular forms “a,” “an,” and “the” are intended to include the plural forms as well, unless the context clearly indicates otherwise.

According to some aspects of the technology described herein, a mechanism for biometric authentication of a user on a user device can be implemented that combines a fingerprint scanner and a heart rate monitor into a single scanner button, for example a single biometric sensor. The fingerprint scanner, or fingerprint reader, comprises a camera on or around the edge of a biometric sensor button and can detect the ridges and minutia of a user's fingerprint. Once a user's fingerprint is scanned it can be compared to a stored fingerprint, for example the user device's or account owner's fingerprint, to authenticate the potential user's fingerprint and identity. The biometric sensor can also comprise a light-emitting diode (LED) and an optical input device, for example a camera, in the middle of the biometric sensor, more specifically in the middle of the fingerprint scanner. The LED shines a sharp light to illuminate the finger of the user and the device can measure biometric signals, for example, color variations in the illuminated finger, to detect and/or establish a heart rate of the user. Through a variety of algorithms stored in association with the user device, and stored data about the user's heart rate, in some instances corresponding to various activity levels, the user device can determine if the fingerprint is coming from a live person or if the person is under duress or sleeping. The received heartrate data can then be validated, in some instances validated within allowable parameters for the user, and if the validation is successful access to the user device can be enabled. According to various embodiments, the technology described herein combines a fingerprint scanner and a heart rate detector into one biometric sensor button such that multiple modes of user biometric information may be used simultaneously for authentication, i.e. during a single login event. In some implementations, various benchmarks and tolerances may be recorded and loaded into the authentication modules and mapped against real-time received data to authenticate a user attempting to access a user device or an application on the user device.

The biometric sensor can be integrated into a user device or in otherwise operable communication with the user device. The biometric sensor comprising the fingerprint scanner and the heartrate detector, the heartrate detector comprising the optical input device and the LED, can initially detect a physical contact between a user's finger and the biometric sensor. When the physical contact is detected by the biometric sensor, the fingerprint scanner and the heartrate detector can be activated or otherwise initialized. The fingerprint scanner, which can be implemented as a camera, can scan the user's fingerprint and detect, amongst other things, the ridges and other minutiae to obtain a full scan or representation of the user's fingerprint. The scanned fingerprint can then be compared to a stored fingerprint, or authentication fingerprint, to authenticate the fingerprint of the user. In some instances the user device can compare, using for example imaging technologies, the features of the scanned print pattern to the authentication print pattern to determine that the prints are a match. The stored authentication fingerprint can be received by the user device during an enrollment process.

The heartrate detector can receive a plurality of detectable biometric signals corresponding to a user's heartrate to determine a measured heartrate of the user during the physical contact between the user's finger and the biometric sensor. The LED can shine a sharp light to illuminate the finger of the user and the camera can receive optical input data, such as color variations in the illuminated finger. The optical input data can be processed by the user device to determine the measured heartrate. The measured heartrate of the user can subsequently be mapped to a stored validation profile for the user comprising a heartrate benchmark. The user device can determine that the measured heartrate is within or outside of a tolerance range corresponding to the heartrate benchmark of the validation profile. The measured heartrate can then be validated based on a generated indication that the measured heartrate is within the tolerance range. The measured heartrate will not be validated based on a generated indication that the measured heartrate is outside of the tolerance range. Access to the user device can be enabled based on a validated measured heartrate and an indication that the fingerprint is authenticated. In some embodiments, the validation profile can be created during an enrollment process. In some further embodiments, the validation profile can be one of a plurality of stored validation profiles each comprising a benchmark, a variance, and a tolerance. In some instances, each validation profile can correspond to an activity level of a user, for example walking, running, or at rest. During the heartrate validation process, the user device can utilize, for example, GPS and/or gyroscope technology to determine which validation profile the measured heartrate needs to be mapped to.

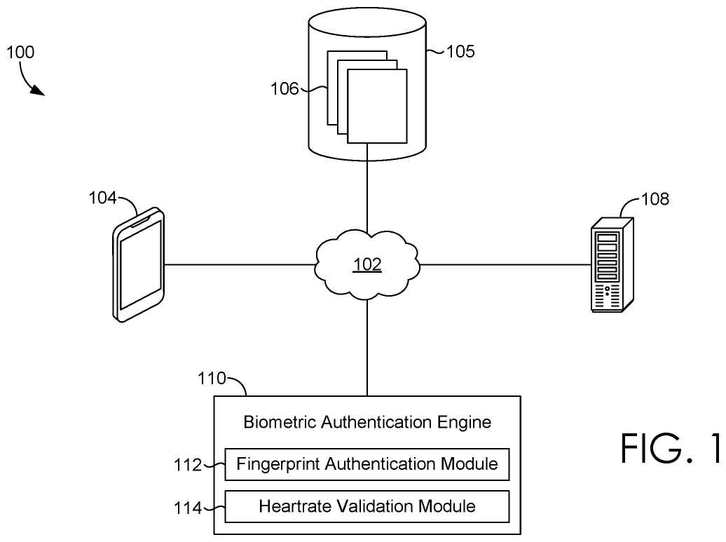

Referring now to the figures, with reference to FIG. 1, FIG. 1 depicts a block diagram of an exemplary computing environment 100 in which some embodiments of the present disclosure can be employed. It should be understood that this and other arrangements described herein are set forth only as examples. Other arrangements and elements (e.g., machines, interfaces, functions, orders, and groupings of functions) can be used in addition to or instead of those shown, and some elements can be omitted altogether for the sake of clarity. Further, many of the elements described herein are functional entities that can be implemented as discrete or distributed components or in conjunction with other components, and in any suitable combination and location. Various functions described herein as being performed by one or more entities can be carried out by hardware, firmware, and/or software. For instance, some functions can be carried out by a processor executing instructions stored in memory.

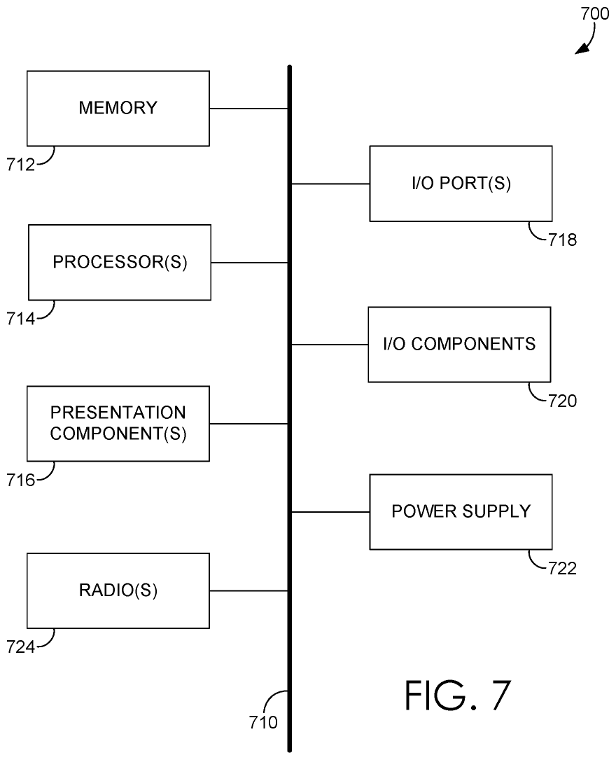

Among other components not shown, example operating environment 100 includes a client device or user device, such as client device 104. Each of the components shown in FIG. 1 can be implemented via any type of computing device, such as computing device 700 described in connection to FIG. 7, for example. These components can communicate with each other via network 102, which can include, without limitation, one or more local area networks (LANs) and/or wide area networks (WANs). In exemplary implementations, network 130 comprises the Internet and/or a cellular network, amongst any of a variety of possible public and/or private networks. In some embodiments, biometric authentication engine 110 and validation profiles 106 can be stored and/or be implemented on user device 104. In some instances user profiles 106 may be stored on a remote server, for example server 108.

It should be understood that any number of user devices, servers, and data sources 105 can be employed within operating environment 100 within the scope of the present disclosure. Each can comprise a single device or multiple devices cooperating in a distributed environment. Additionally, other components not shown can also be included within the distributed environment.

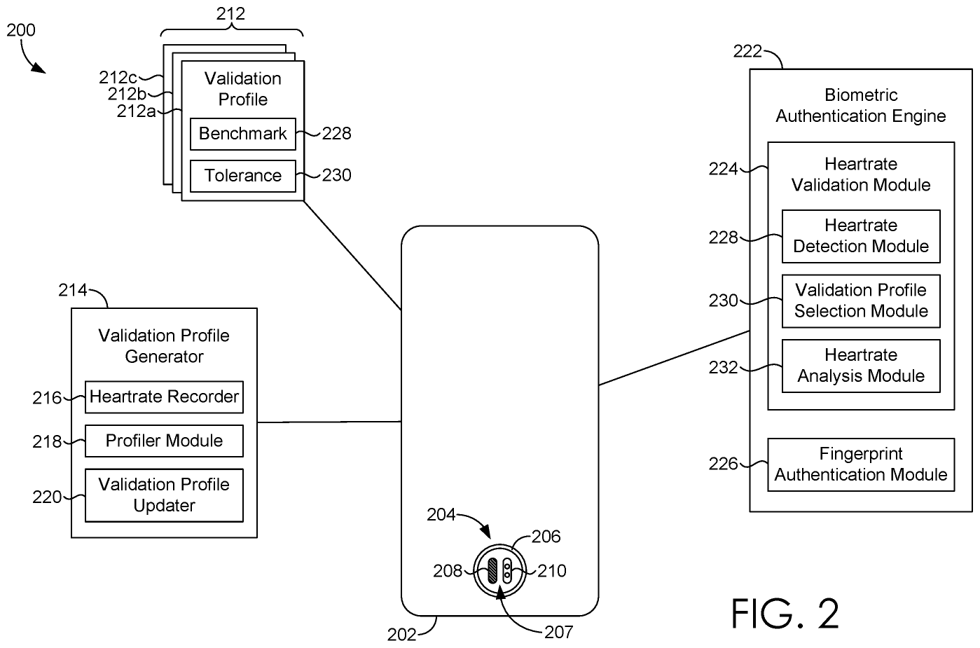

User device 104 can comprise any type of computing device or client device capable of use by a user that includes a biometric sensor as described herein. By way of example and not limitation, a user device 104 can include a biometric authentication engine 110 configured to run on the user device. The biometric authentication engine 110 can comprise a fingerprint authentication module 112 and a heartrate validation module 114. The biometric authentication module 110 can operate in conjunction with user device 104 and more particularly the biometric sensor of user device 104. In some embodiments, the functions of the technology described herein can be interpreted, analyzed, or otherwise processed by biometric authentication engine 110. Biometric authentication engine 110 can be configured to operate in conjunction with a biometric sensor integrated into user device 104. Based on biometric input data received by the biometric sensor (e.g. biometric sensor 204 of FIG. 2) of user device 104, the fingerprint authentication module 112 can authenticate a fingerprint of a user and the heartrate validation module 114 can validate the heartrate of a user, for example operating in conjunction with validation profiles 106.

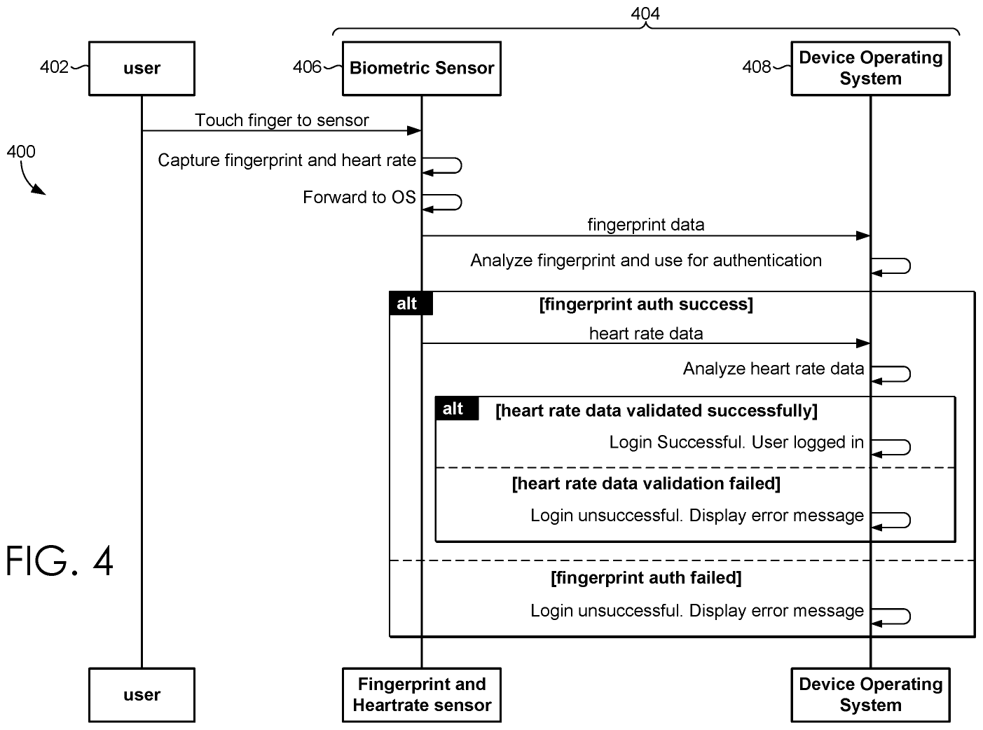

Data storage 105 can comprise data sources and/or data systems, which are configured to make data available to any of the various constituents of operating environment 100, or systems 200 and 400 described in connection to FIGS. 2 and 4. For example, in one embodiment, one or more data sources 105 can provide (or make available for access) datasets for use by any client device, for example user device 104. Data source 105 can be discrete from user device 104 and/or server 108 or can be incorporated and/or integrated into at least one of such components. In some embodiments, user device 104 can retrieve one or more datasets from the data source 105, such that user device 104 can independently store and employ the dataset(s). In some embodiments, data source 105 can comprise a single dataset or a collection of datasets, which can be shared amongst multiple user devices. In various embodiments, the data source 110 stores a shared collection of datasets that can be interpreted, analyzed, and/or processed by user device 104, for example by utilizing biometric authentication engine 110.

Continuing with FIG. 2, a block diagram depicting an exemplary computing architecture 200 is provided, in accordance with some aspects of the technology described herein. A biometric sensor 204 can be integrated into user device 202. The biometric sensor 204 can comprise a fingerprint scanner 206, for example a camera, and a heartrate detector 207. The heartrate detector can comprise a LED 210 (which can be implemented as a plurality of LEDs) and an optical input device 208, for example a camera. When the biometric sensor 204 detects a physical contact by a user's finger, the fingerprint scanner 206 and the heartrate detector 207 can be activated. If not already running on user device 202, upon the activation of fingerprint scanner 206 and heartrate detector 207 a biometric authentication engine 222 can be initialized. The biometric authentication engine 222 can comprise a plurality of modules that can be employed during the authentication process, for example fingerprint authentication module 226 and heartrate validation module 224. Heartrate validation module can comprise, among other things, a heartrate detection module 228, a validation profile selection module 230, and a heartrate analysis module. Once fingerprint scanner 206 and heartrate detector 207 are activated by the physical contact between the user's finger and biometric sensor 204, the fingerprint scanner 206 can scan the user's finger and extract print pattern feature data. For example, print pattern features can be the ridges of a user's fingerprint or other minutiae points. In some embodiments, fingerprint scanner 206 can aggregate the characteristics of the ridges and other minutiae points to create a full or partial representation of the user's fingerprint. Fingerprint authentication module 226 can receive the fingerprint scan (e.g. via the fingerprint scanner 206) and compare it to a stored authentication fingerprint. The authentication fingerprint can be stored on user device 202 or stored remotely (e.g. data store 105 or server 108). Based on the comparison of the features of the scanned fingerprint and the authentication fingerprint, fingerprint authentication module 226 can verify or otherwise authenticate the user's fingerprint.

Heartrate validation module 224 can determine a measured heartrate of the user based on a plurality of detectable biometric signals received by the heartrate detector 207. LED 210 can illuminate the user's finger during the physical contact with the biometric sensor and optical input device 208 can read or otherwise receive the plurality of biometric signals, for example the variations in color or other optically perceivable signals. Based on the plurality of biometric signals, heartrate detection module 228 can determine a measured heartrate of the user. Validation profile selection module 230 can select a validation profile 212 based on the measured heartrate of the user. In some embodiments, one validation profile 212 is stored in association with the user and user device 202. In other embodiments, a plurality of validation profiles 212a, 212b, 212c, can be stored in association with the user and user device 202. Each validation profile 212a, 212b, 212c can comprise a benchmark 228 and a tolerance 230. In some embodiments, validation profile selection module 230 can select a validation profile 212a, 212b, 212c based on a determined activity level of the user. Additional technology integrated into user device 202 (e.g. GPS, gyroscope technology, or other positioning and movement recognition technology) can be utilized by validation profile selection module 230 to select an appropriate validation profile 212a, 212b, 212c based on the determined activity level. For example, if it is determined that the user is at rest, validation profile 212a may be selected for the authentication process. Alternatively, if a user is walking validation profile 212b may be selected for the authentication process. It will be appreciated that each validation profile 212a, 212b, 212c can have different benchmarks 228 or tolerance ranges 230.

Heartrate analysis module 232 can map the measured heartrate of the user to the selected validation profile 212, for example the measured heartrate of the user can be mapped to benchmark 228 of validation profile 212. Heartrate analysis module 232 can analyze, process, or otherwise determine is the measured heartrate of the user is within a tolerance range 230 corresponding to the heartrate benchmark 228 of the validation profile 212. If the measured heartrate is within tolerance range 230, an indication can be generated that the measured heartrate is validated. If the measured heartrate is outside of tolerance range 230, an indication can be generated that the measured heartrate is not validated. Access to the user device can subsequently be enabled by biometric authentication engine 222 based on the authenticated fingerprint (via fingerprint authentication module 226) and the validated measured heartrate (via heartrate validation module 224).

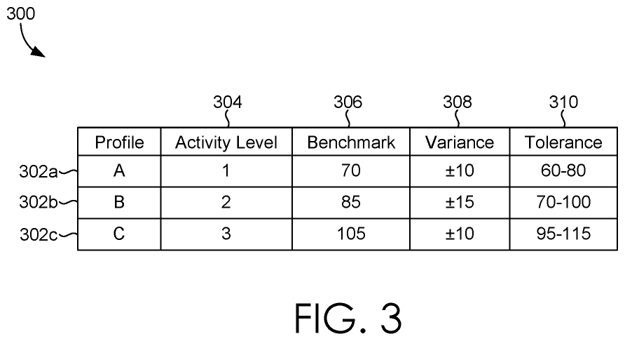

Validation profile generator 214 can be implemented to create and/or update one or more validation profiles 212a, 212b, 212c. During an initial enrollment process, a validation profile 212 can be created by validation profile generator 214 by measuring and recording (e.g. by heartrate recorder 216) a user's heartrate. Profiler module can generate or otherwise build a validation profile 212 based on a measured heartrate of the user received by heartrate detector 207. Profile module 218 can generate a benchmark (e.g. benchmark 228), tolerance range (e.g. tolerance 230), and determine a heartrate variance (e.g. 310 of FIG. 3). Profiler module 218 can generate benchmark 228 based on the measured heartrate of the user during enrollment as well as set an initial tolerance range 230. After enrollment, heartrate recorder 216 can record a measured heartrate of the user each time access to user device 202 is enabled. Over time, a plurality of measured heartrates of the user can be recorded and profiler module 218 and/or validation profile updater can for example average the measured heartrates and adjust benchmark 228. Thus, heartrate benchmark 228 can be calculated over a temporal interval. In some embodiments, heartrate benchmark 228 can be a weighted average of the plurality of measured heartrates. Further, based on the plurality of measured heartrates, profiler module 218 and validation profile updated 220 can determine a variance of the user's heartrate over time. It will be appreciated that the temporal interval used for calculating benchmark 228 and/or variance can be any interval selected. For example, validation profile generator 214 can calculate benchmark 228, variance, and tolerance range 230 based on a plurality of measured heartrates over e.g. a day, a week, a month, a year, and so forth. The temporal interval can in some embodiments be a moving interval. The variance of the user's heartrate can be utilized to adjust tolerance range 230 associated with one or more validation profiles 212a, 212b, 212c. In some embodiments, the system can use the measured heartrate of the last n successful authentication attempts to analyze and calculate the benchmark and variance of the user during a certain activity.

Turning now to FIG. 3, a diagram of an example validation profile set 300 for use in authentication processes to enable access to a user device is depicted, in accordance with some aspects of the technology described herein. Validation profile set 300 can comprise one or more validation profiles 302a, 302b, 302c, which can correspond to validation profiles 212a, 212b, 212c of FIG. 2. Each validation profile 302a, 302b, 302c, can comprise one or more variables, such as activity level 304, benchmark 306, variance 308, and tolerance 310. Validation profiles 302a, 302b, 302c can be generated for example by validation profile generator 214 of FIG. 2. During an enrollment of the authentication system, the heartrate of a user can be measured to determine an initial benchmark 306 for a validation profile 302a, 302b, 302c. Based on the initial benchmark 306 an initial variance 308 can be determined, and based on the initial variance 308, an initial tolerance range 310 can be determined. Additionally, an activity level 304 can be assigned to each validation profile 302a, 302b, 302c. Each time access to the user device is enabled, the measured heartrate of the user can be recorded (e.g. by heartrate recorder 216 of FIG. 2) and benchmark 306 can be calculated or recalculated based on a plurality of measured heartrates, or a generated timeseries of heartrate measurements (e.g. by profiler module 218 and/or validation profile updater 220 of FIG. 2). As such, benchmark 306 can be a weighted average of recorded user heartrates over a given temporal interval. Variance 308 can also be calculated, recalculated or otherwise updated (e.g. by profiler module 218 and/or validation profile updater 220 of FIG. 2) based on the plurality of measured heartrates over the given temporal interval. In this way, with respect to benchmark 306 and variance 308, the system profiles a user's measured heartrate based on recent history and can continuously adapt to a user's recent state for a given activity level. In some embodiments, a timeseries of heartrate measurements can be generated and stored in association with the user device and/or validation profiles. Based on benchmark 306 and variance 308, tolerance range 310 can be determined, recalculated or otherwise updated. The tolerance range 310 for a user's measured heartrate as compared to their average heartrate (e.g. benchmark 306) can be calculated using any number of statistical methods based on the measured heartrate history (e.g. timeseries of heartrate measurements). For example location tests such as a Z-test, T-test, or sign-test can be utilized. It will be appreciated that a p-value threshold can be implemented to govern the tolerance range 310. For example, a determined p-value of 0.01 will indicate that there is only a 1% probability of the measured heartrate being consistent with the user's measured heartrate history. Additionally, anomaly or other outlier detection methods may be implemented to ensure that the measured heartrate history is free from noisy data. The heartrate benchmark 306, the heartrate variance 308, and the heartrate tolerance range 310 can be stored in association with one or more validation profiles 302a, 302b, 302c. Additionally, in some embodiments, the tolerance can be configurable by a system administrator.

Turning now to FIG. 4, a schematic of an example system and communication diagram 400 in operation for authenticating a user 402 on a user device 404 based on multifactor biometric authentication, in accordance with some aspects of the technology described herein, is depicted. A user device 404 comprising a biometric sensor 406 can detect a physical contact between a user's finger and the biometric sensor 406. Based on the detected physical contact, a fingerprint scanner and a heartrate detector of the biometric sensor 406 can be activated. Fingerprint data and heartrate data of the user 402 can be captured by the biometric sensor 406. The fingerprint data and the heartrate data can be forwarded to the user device operating system 408 or an application running on user device 404. In some embodiments, this can be a computing agent running on user device 404. The fingerprint data can be analyzed (e.g. by fingerprint authentication module 226 of FIG. 2) by user device 404 to be used for authentication. Simultaneously or subsequently, the heart rate data can be analyzed (e.g. by heartrate validation module 224 of FIG. 2) by user device 404 to be used for authentication. If the fingerprint data is successfully authenticated and the heartrate data is successfully authenticated or otherwise validated, access to user device 404 is enabled (i.e. the login attempt is successful). If one of the fingerprint data and/or the heartrate data is not successfully authenticated or otherwise validated, access to user device 404 is not enabled (i.e. the login attempt is not successful). In some embodiments, if the fingerprint data is authenticated, and the heartrate data is invalidated, access to user device 404 can be enabled, but user device 404 can be caused to trigger an alert to the user or a third party, present false data to the user, and/or hide or otherwise obscure sensitive data. If access to the user device is denied based on multifactor biometric authentication, the system can request additional authentication credentials, for example non-biometric authentication credentials such as a pin, username/password, or other authentication token.

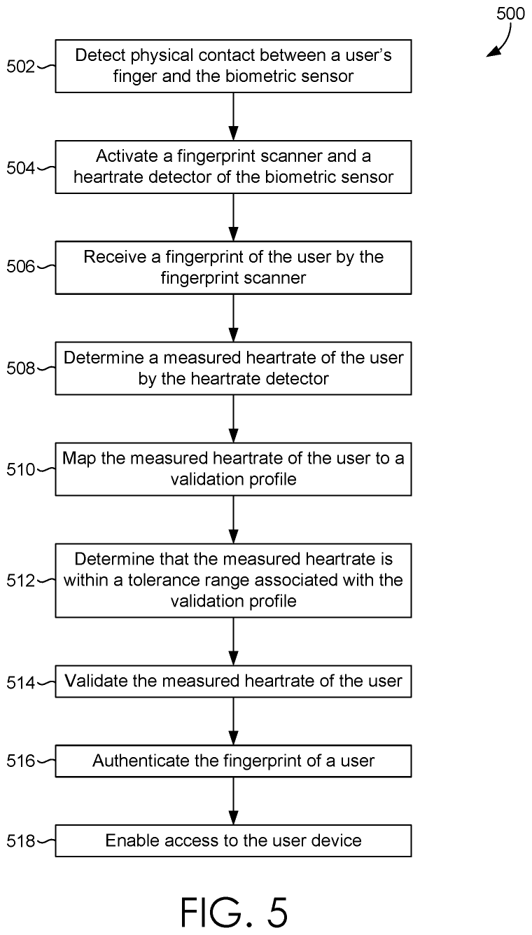

Turning now to FIG. 5, a flow diagram is provided illustrating one example method 500 for authenticating a user on a user device utilizing biometrics received via a biometric sensor, in accordance with some aspects of the technology described herein. It is contemplated that each block or step of method 400 and other methods described herein comprises a computing process that can be performed using any combination of hardware, firmware, and/or software. For instance, various functions can be carried out by a processor executing instructions stored in memory. The methods can also be embodied as computer-usable instructions stored on computer storage media. The methods can be provided by a stand-alone application, a service or hosted service (stand-alone or in combination with another hosted service), or a plug-in to another product, to name a few.

At step 502, physical contact is detected between a user's finger and a biometric sensor of a user device, the biometric sensor comprising a fingerprint scanner and a heartrate detector. Based on the detected physical contact, at step 504 the fingerprint scanner and the heartrate detector of the biometric scanner are activated. At step 506, a fingerprint, or fingerprint data, of the user can be received by the fingerprint scanner. Heartrate data of the user can be received by the heartrate detector, and at step 508 a measured heartrate of the user can be determined. At step 510, the measured heartrate of the user can be mapped to a validation profile, in some instances the validation profile is selected from amongst a plurality of validation profiles. The measured heartrate of the user can be mapped to the validation profile based on at least one of a heartrate benchmark corresponding to the validation profile and an activity level corresponding to the validation profile. At step 512 it can be determined that the measured heartrate is with a tolerance range corresponding to the validation profile, and based on that determination, the measured heartrate of the user can be validated. At step 516 the acquired fingerprint or fingerprint data of the user can be authenticated, e.g. by a biometric matching function. Based on the validated measured heartrate of the user and the authenticated fingerprint of the user, at step 518 access to the user device can be enabled.

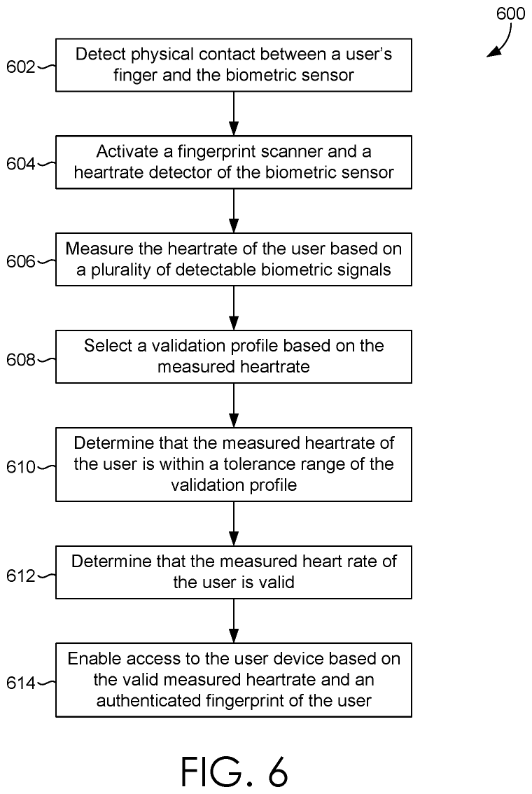

Turning now to FIG. 6, a flow diagram is provided illustrating one example method 600 for authenticating a user on a user device utilizing biometrics received via a biometric sensor, in accordance with some aspects of the technology described herein. At step 602, physical contact is detected between a user's finger and a biometric sensor of a user device, the biometric sensor comprising a fingerprint scanner and a heartrate detector. Based on the detected physical contact, at step 604 the fingerprint scanner and the heartrate detector of the biometric scanner are activated. Based on a plurality of detectable biometric signals, the heartrate of the user can be measured. At step 608, a validation profile for the user can be selected based on the measured heartrate. In some embodiments, the validation profile can be selected based on additional information, such as a determined activity level. At step 610 it can be determined that the measured heartrate of the user is within a tolerance range corresponding to the selected validation profile. If it is determined that the measured heartrate is within the tolerance range of the selected profile, at step 612 it can be determined, or an indication can be generated, that the heartrate of the user is valid. Alternatively, if it is determined that the measured heartrate is outside of the tolerance range of the selected profile an indication can be generated that the measured heartrate of the user is invalid. At step 614, access to the user device can be enabled based on the indication that the measured heartrate is valid and a fingerprint of the user has been authenticated.

Having described various embodiments of the invention, an exemplary computing environment suitable for implementing embodiments of the invention is now described. With reference to FIG. 7, an exemplary computing device is provided and referred to generally as computing device 700. The computing device 700 is but one example of a suitable computing environment and is not intended to suggest any limitation as to the scope of use or functionality of the invention. Neither should the computing device 700 be interpreted as having any dependency or requirement relating to any one or combination of components illustrated.

Embodiments of the invention can be described in the general context of computer code or machine-useable instructions, including computer-useable or computer-executable instructions, such as program modules, being executed by a computer or other machine, such as a personal data assistant, a smartphone, a tablet PC, or other handheld device. Generally, program modules, including routines, programs, objects, components, data structures, and the like, refer to code that performs particular tasks or implements particular abstract data types. Embodiments of the invention can be practiced in a variety of system configurations, including handheld devices, consumer electronics, general-purpose computers, more specialty computing devices. Embodiments of the invention can also be practiced in distributed computing environments where tasks are performed by remote-processing devices that are linked through a communications network. In a distributed computing environment, program modules can be located in both local and remote computer storage media including memory storage devices.

With reference to FIG. 7, computing device 700 includes a bus 710 that directly or indirectly couples the following devices: memory 712, one or more processors 714, one or more presentation components 716, one or more input/output (I/O) ports 718, one or more I/O components 720, and an illustrative power supply 722. Bus 710 represents what can be one or more buses (such as an address bus, data bus, or combination thereof). Although the various blocks of FIG. 7 are shown with lines for the sake of clarity, in reality, these blocks represent logical, not necessarily actual, components. For example, one can consider a presentation component such as a display device to be an I/O component. Also, processors have memory. The inventors hereof recognize that such is the nature of the art and reiterate that the diagram of FIG. 7 is merely illustrative of an exemplary computing device that can be used in connection with one or more embodiments of the present invention. Distinction is not made between such categories as “workstation,” “server,” “laptop,” “tablet,” “client device/system,” “user device,” or “computing device” as all are contemplated within the scope of FIG. 7.

Computing device 700 typically includes a variety of computer-readable media. Computer-readable media can be any available media that can be accessed by computing device 700 and includes both volatile and nonvolatile, removable and non-removable media. By way of example, and not limitation, computer-readable media can comprise computer storage media and communication media. Computer storage media includes both volatile and nonvolatile, removable and non-removable media implemented in any method or technology for storage of information such as computer-readable instructions, data structures, program modules, or other data. Computer storage media includes, but is not limited to, RAM, ROM, EEPROM, flash memory or other memory technology, CD-ROM, digital versatile disks (DVDs) or other optical disk storage, magnetic cassettes, magnetic tape, magnetic disk storage or other magnetic storage devices, or any other medium which can be used to store the desired information and which can be accessed by computing device 700. Computer storage media does not comprise signals per se. Communication media typically embodies computer-readable instructions, data structures, program modules, or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media, such as a wired network or direct-wired connection, and wireless media, such as acoustic, RF, infrared, and other wireless media. Combinations of any of the above should also be included within the scope of computer-readable media.

Memory 712 includes computer storage media in the form of volatile and/or nonvolatile memory. The memory can be removable, non-removable, or a combination thereof. Exemplary hardware devices include solid-state memory, hard drives, optical-disc drives. Computing device 700 includes one or more processors 614 that read data from various entities such as memory 712 or I/O components 720. Presentation component(s) 716 presents data indications to a user or other device. Exemplary presentation components include a display device, speaker, printing component, vibrating component, and the like.

The I/O ports 718 allow computing device 700 to be logically coupled to other devices, including I/O components 720, some of which can be built in. Illustrative components include a microphone, joystick, game pad, satellite dish, scanner, printer, wireless device. Some embodiments of computing device 700 can include one or more radio(s) 724 (or similar wireless communication components). The radio 724 transmits and receives radio or wireless communications. The computing device 700 can be a wireless terminal adapted to receive communications and media over various wireless networks. Computing device 700 can communicate via wireless protocols, such as code division multiple access (“CDMA”), global system for mobiles (“GSM”), or time division multiple access (“TDMA”), as well as others, to communicate with other devices. The radio communications can be a short-range connection, a long-range connection, or a combination of both a short-range and a long-range wireless telecommunications connection. When we refer to “short” and “long” types of connections, we do not mean to refer to the spatial relation between two devices. Instead, we are generally referring to short range and long range as different categories, or types, of connections (i.e., a primary connection and a secondary connection). A short-range connection can include, by way of example and not limitation, a Wi-Fi® connection to a device (e.g., mobile hotspot) that provides access to a wireless communications network, such as a WLAN connection using the 802.11 protocol; a Bluetooth connection to another computing device is a second example of a short-range connection, or a near-field communication connection. A long-range connection can include a connection using, by way of example and not limitation, one or more of CDMA, GPRS, GSM, TDMA, and 802.16 protocols.

Many different arrangements of the various components depicted, as well as components not shown, are possible without departing from the scope of the claims below. Embodiments of the present invention have been described with the intent to be illustrative rather than restrictive. Alternative embodiments will become apparent to readers of this disclosure after and because of reading it. Alternative means of implementing the aforementioned can be completed without departing from the scope of the claims below. Certain features and sub-combinations are of utility and can be employed without reference to other features and sub-combinations and are contemplated within the scope of the claims.

What is claimed is:

1. A method comprising:
detecting, using a biometric sensor in communication with a user device, physical contact between a user's finger and the biometric sensor, the biometric sensor comprising a fingerprint scanner and a heartrate detector, wherein the heartrate detector comprises a camera and a light emitting diode;
activating the fingerprint scanner and the heartrate detector based on the detected physical contact;
determining a measured heartrate of the user based on a plurality of detectable biometric signals received via the heartrate detector;
mapping the measured heartrate of the user to a validation profile, the validation profile comprising a heartrate benchmark;
determining that the measured heartrate of the user is within a tolerance range corresponding to the heartrate benchmark of the validation profile;
validating the measured heart rate of the user based on an indication that the measured heartrate is within the tolerance range;
authenticating the fingerprint of the user by comparing a fingerprint of the user received by the fingerprint scanner and a stored authentication fingerprint; and
enabling access to the user device based on the validated measured heartrate and the authenticated fingerprint.

2. The method of claim 1, further comprising: recording, by the user device, the determined measured heartrate of the user each time access to the user device is enabled; and
calculating the heartrate benchmark over a temporal interval.

3. The method of claim 2, further comprising determining a heartrate variance for a user over the temporal interval.

4. The method of claim 3, wherein the validation profile further comprises the heartrate variance.

5. The method of claim 3, further comprising calculating the tolerance range based on the determined heartrate variance.

6. The method of claim 1, wherein the validation profile is selected from a plurality of validation profiles based on the measured heartrate of the user and a determined activity level of the user.

7. The method of claim 1, further comprising: invalidating the measured heart rate of the user based on an indication that the measured heartrate is outside the tolerance range.

8. The method of claim 7, further comprising: enabling access to the user device based on the invalidated measured heartrate and the authenticated fingerprint and causing the user device to at least one of: trigger an alert, present false data, and hide sensitive data.

9. The method of claim 7, further comprising: preventing access to the user device based on the invalidated measured heartrate and the authenticated fingerprint.

10. A computer storage media, having instructions stored thereon that, when executed by at least one processor of a computing system, cause the computing system to:
detect, via a biometric sensor in communication with a user device, physical contact between a user's finger and the biometric sensor, the biometric sensor comprising a fingerprint scanner and a heartrate detector, wherein the heartrate detector comprises a camera and a light emitting diode;
activate the fingerprint scanner and the heartrate detector based on the detected physical contact;
measure the heartrate of the user based on a plurality of detectable biometric signals received via the heartrate detector;
select a validation profile based on the measured heartrate by referencing a heartrate benchmark of the validation profile;
determine that the measured heartrate of the user is within a tolerance range, the tolerance range corresponding to the heartrate benchmark of the validation profile;
determine that the measured heart rate of the user is valid based on an indication that the measured heartrate is within the tolerance range; and
enable access to the user device based on the valid measured heartrate and an indication that a scanned fingerprint of the user has been authenticated.

11. The computer storage media of claim 10, further causing the system to:
record the measured heartrate of the user each time access to the user device is enabled; and
calculate the heartrate benchmark over a temporal interval.

12. The computer storage media of claim 11, further comprising determining a heartrate variance for a user over the temporal interval, the heartrate variance corresponding to the heartrate benchmark.

13. The computer storage media of claim 12, further comprising: calculating the tolerance range based on the heartrate variance.

14. The computer storage media of claim 10, wherein the validation profile is selected from amongst a plurality of validation profiles, each validation profile corresponding to an activity level.

15. The computer storage media of claim 14, wherein the validation profile is selected based on the heartrate benchmark and a determined activity level, the activity level determined by the user device.

16. The computer storage media of claim 10, further comprising: causing the system to determine that the measured heart rate of the user is invalid based on an indication that the measured heartrate is outside of the tolerance range.

17. A computerized system for authenticating a user comprising:
a biometric sensor, the biometric sensor comprising a fingerprint scanner and a heartrate detector, wherein the heartrate detector comprises a camera and a light emitting diode; and
a user device in communication with the biometric sensor, the user device comprising
a processor; and
a computer storage medium storing computer-useable instructions that, when used by the processor, cause the processor to:
detect physical contact between a user's finger and the biometric sensor;
activate the fingerprint scanner and the heartrate detector based on the detected physical contact;
measure, by the heartrate detector, a heartrate of the user based on a plurality of received detectable biometric signals;
select a validation profile based on the measured heartrate by referencing a heartrate benchmark of the validation profile;
determine that the measured heartrate of the user is within a authentication tolerance range, the tolerance range associated with the heartrate benchmark of the validation profile;
determine that the measured heart rate of the user is valid based on an indication that the measured heartrate is within the tolerance range; and
enabling access to the user device based on the valid measured heartrate and an indication that a scanned fingerprint of the user has been authenticated.

18. The computerized system of claim 17, further comprising causing the processor to:
record the measured heartrate of the user each time access to the user device is enabled to generate a timeseries of heartrate measurements;
calculate the heartrate benchmark based on the timeseries of heartrate measurements;
determine a heartrate variance for a user corresponding to the heartrate benchmark based on the timeseries of heartrate measurements;
calculate the tolerance range based on the heartrate benchmark and the heartrate variance; and
storing the heartrate benchmark, the heartrate variance, and the tolerance range in association with the validation profile.

19. The computerized system of claim 17, further comprising causing the processor to select the validation profile from amongst a plurality of validation profiles based on the heartrate benchmark and a determined activity level.

20. The computerized system of claim 17, further comprising causing the processor to determine that the measured heart rate of the user is invalid based on an indication that the measured heartrate is outside of the tolerance range
